(19) United States
(12) Patent Application Publication
(10) Pub. No.: US 2025/0222394 A1
(43) Pub. Date: Jul. 10, 2025

(54) PROCESS FOR SEPARATING CARBON DIOXIDE FROM SYNTHESIS GAS

(71) Applicant: L'Air Liquide, Societe Anonyme pour l'Etude et l’Exploitation des Procedes Georges Claude, Paris (FR)

(72) Inventors: Sophia SCHMIDT, Frankfurt am Main (DE); Matthias LINICUS, Frankfurt am Main (DE); Martin RAVENTOS, Paris (FR)

(21) Appl. No.: 19/014,186

(22) Filed: Jan. 8, 2025

(30) Foreign Application Priority Data
Jan. 8, 2024 (EP) EP 24150688

(51) Int. Cl. B01D 53/14; B01D 53/04; C01B 3/52; C01B 32/50

(52) U.S. Cl. CPC B01D 53/1475; B01D 53/04; B01D 53/1425; C01B 3/52; C01B 32/50; B01D 2252/2021; B01D 2253/116; B01D 2256/16; B01D 2257/504; B01D 2259/4009; C01B 2203/0415; C01B 2203/0475

(57) ABSTRACT

A process for producing hydrogen from a synthesis gas stream, in which carbon dioxide is removed from the synthesis gas stream by absorption. After the carbon dioxide has been desorbed from the absorption medium, absorption medium present in the resulting carbon dioxide stream is removed by adsorption on a solid adsorbent, for example owing to a molecular sieve effect. A portion of the carbon dioxide stream thus obtained, now free of absorption medium, is heated and used for regeneration of the laden solid adsorbent. The invention further provides a plant for performing the process according to the invention.

### CROSS-REFERENCE TO RELATED APPLICATIONS

This application claims the benefit of priority under 35 U.S.C. § 119 (a) and (b) to EP patent application No. EP 24150688, filed Jan. 8, 2024, the entire contents of which are incorporated herein by reference.

### BACKGROUND

### Field of the Invention

The invention relates to a process and to a plant for separation of carbon dioxide from a synthesis gas stream comprising at least hydrogen (H₂) and carbon dioxide (CO₂).

### Related Art

In the case of hydrogen production from synthesis gas, carbon dioxide is formed in the reforming of fossil feedstocks and a downstream water-gas shift. The synthesis gas mixture formed, which now comprises hydrogen and carbon dioxide as its main components, is then freed of carbon dioxide. The carbon dioxide stream formed thereby can be used further or sequestered. For further use, this stream, depending on the particular application, may be provided in gaseous or liquid form.

If the carbon dioxide product is required in liquid form, liquefaction is typically effected by cooling and compression. A prerequisite for this is that the carbon dioxide is largely free of trace impurities that impair liquefaction, and is free of water, such that freezing in the apparatuses used during cooling below the freezing point of water is prevented.

A physical or chemical absorption process may be used for the removal of carbon dioxide from the shifted synthesis gas.

Useful absorption media in physical absorption processes may be solvents such as methanol, N-methyl-2-pyrrolidone, mixtures of dimethyl ethers of polyethylene glycol, and propylene carbonate (4-methyl-1,3-dioxolan-2-one).

Useful absorption media in physical absorption processes may be solvents such as methanol, N-methyl-2-pyrrolidone, mixtures of dimethyl ethers of polyethylene glycol, and propylene carbonate (4-methyl-1,3-dioxolan-2-one).

Useful absorption media in chemical scrubbing operations especially include amines such as monoethanolamine (MEA), diethanolamine (DEA), methyldiethanolamine (MDEA), diglycolamine (DGA), or aminomethylpropanol (AMP). The effect of the chemical absorption may be enhanced by a promoter such as piperazine (PZ). Ammonia solutions, especially aqueous ammonia solutions, are likewise known as absorption media for carbon dioxide.

In the aforementioned processes, intolerable residual amounts of absorption medium are found in the carbon dioxide product after desorption from the absorption medium for the liquefaction of carbon dioxide, and these therefore have to be removed.

When a polar, i.e. water-soluble, absorption medium is used, this can be removed by a scrubbing operation with water in a separate scrubbing column.

However, such a configuration has several drawbacks. Firstly, an additional auxiliary is required, namely demineralized water or boiler feed water. Secondly, an additional column is required exclusively for the water scrubbing operation. Thirdly, particular components in contact with the medium have to be made from stainless steel since carbon dioxide and water form carbonic acid as a corrosive medium. Fourthly, a further system for the separation of the water from the carbon dioxide has to be integrated into the plant. And fifthly, the scrubbing water has to be thermally separated from the methanol removed by distillation in the distillation column that is typically present. Because of large additional amounts of water, this increases the energy demand of the process.

A further means of removing the absorption medium is condensation thereof by supply of cooling energy, for example in a coolant-operated heat exchanger, and subsequent recycling of the absorption medium to the absorption column. The disadvantage of this solution is a high demand for energy and demand for additional equipment.

In general terms, it is therefore an object of the present invention to at least partially overcome the abovementioned drawbacks.

The independent claims make a contribution to the at least partial achievement of at least one of the above objects. The dependent claims provide preferred embodiments which contribute to at least partial achievement of at least one of the objects. Preferred embodiments of constituents of one category according to the invention are, where relevant, likewise preferred for identically named or corresponding constituents of a respective other category according to the invention.

The terms “having”, “comprising” or “containing” etc. do not preclude the possible presence of further elements, ingredients etc. The indefinite article “a” does not preclude the possible presence of a plurality.

### SUMMARY OF THE INVENTION

The objects of the invention are at least partly achieved by a process for separating carbon dioxide from a synthesis gas stream comprising at least hydrogen (H₂) and carbon dioxide (CO₂), having the process steps of
(a) providing an absorption medium;
(b) removing carbon dioxide from the synthesis gas stream by absorption, giving a carbon dioxide-laden absorption medium and a hydrogen-containing product stream;
(c) desorbing carbon dioxide from the laden absorption medium by a desorption step, giving a carbon dioxide-depleted absorption medium and an absorption medium-containing carbon dioxide product stream;
(d) removing absorption medium from the absorption medium-containing carbon dioxide product stream by adsorption of the absorption medium on a solid adsorbent, giving a carbon dioxide product stream and an absorption medium-laden adsorbent;
(e) discharging a first substream of the carbon dioxide product stream from the process;
(f) heating a second substream of the carbon dioxide product stream to a desorption temperature, giving a regeneration gas stream, and passing the regeneration gas stream through the laden adsorbent, so as to obtain a regenerated adsorbent by desorption of the absorption medium from the adsorbent and an absorption medium-containing regeneration gas stream.

According to the invention, absorption medium entrained by the carbon dioxide product stream is removed by adsorption on a solid adsorbent. The absorption medium-laden adsorbent is then regenerated by means of a heated substream of the absorption medium-free carbon dioxide product stream. Because the product stream is used as a regeneration stream and can be recycled to the plant as an individual stream together with the desorbed absorption medium, no losses of absorption medium and carbon dioxide product occur.

In one embodiment, the absorption medium-containing regeneration gas stream is therefore subsequently fed back to the process.

A preferred embodiment of the process is characterized in that a physical absorption medium is provided in step (a), the carbon dioxide is removed in step (b) by physical absorption at absorption pressure, and the carbon dioxide is desorbed in step (c) by at least one pressure-lowering step at desorption pressure, where the desorption pressure is lower than the absorption pressure.

The physical absorption medium is preferably methanol. In this case, step (a) therefore preferably comprises providing methanol as the physical absorption medium. The carbon dioxide is preferably absorbed in methanol at low temperatures, in particular cryogenic temperatures, in the absorption apparatus according to step (b). The absorption at absorption pressure is preferably conducted in an absorption apparatus. The methanol preferably has a temperature of less than minus 10° C. or of less than minus 20° C. or of less than minus 30° C. or of less than minus 40° C. before entry into the absorption apparatus. The methanol preferably has a temperature of more than minus 70° C. or of more than minus 60° C. before entry into the absorption apparatus.

The absorption apparatus is configured as an absorption column, for example, and is operated at absorption pressure. Absorption pressure is elevated pressure, in particular a pressure markedly above ambient pressure, in particular a pressure of more than 20 bar or more than 30 bar, for example from 20 to 80 bar, preferably 25 to 70 bar, more preferably 35 to 55 bar, more preferably 35 to 45 bar.

In step (c), carbon dioxide is desorbed from the absorption medium, i.e. released again, by lowering the pressure to a desorption pressure. The desorption is preferably conducted in a suitable regeneration apparatus. The regeneration apparatus preferably has a plurality of series-connected flash stages. The flash stages are configured, for example, as flash columns or flash vessels. What is meant by “series-connected”is in particular that the plurality of flash stages are connected in succession and are in fluid communication with one another, in particular that two immediately successive flash stages are in fluid communication. The pressure in any flash stage is lower than the absorption pressure and is preferably lowered from flash stage to flash stage in the flow direction of the absorption medium. The pressure in any downstream flash stage is thus fundamentally lower than the pressure in the flash stage upstream of this flash stage.

A preferred embodiment of the process is characterized in that a chemical absorption medium is provided in step (a), the carbon dioxide is removed in step (b) by chemical absorption at an absorption temperature, and the carbon dioxide is desorbed in step (c) by at least one heating step at a regeneration temperature, where the regeneration temperature is higher than the absorption temperature.

The chemical absorption medium is preferably an amine. Useful absorption media include one or a mixture of the aforementioned amines. The carbon dioxide is absorbed in the chemical absorption medium at an absorption temperature, for example at ambient temperature. The carbon dioxide is desorbed from the chemical absorption medium at a regeneration temperature higher than the absorption temperature. One example is desorption of carbon dioxide from the amine in a regeneration column by heating of the laden amine solution in the bottom of the column by indirect heat exchange with steam.

The synthesis gas is preferably generated by reforming or steam reforming of a fossil feedstock, or by gasification of carbonaceous solids.

The feedstock is preferably natural gas, another hydrocarbonaceous source of fossil origin, or biomass. Examples of carbonaceous solids are wastes such as municipal solid waste, and wood processing wastes.

Examples of reforming processes for generation of the synthesis gas are autothermal reforming (ATR), partial oxidation (POx), and gasification processes such as fixed bed gasification, entrained flow gasification and fluidized bed gasification.

The synthesis gas generated as the primary product by reforming, steam reforming or gasification contains at least hydrogen, carbon monoxide and carbon dioxide. Carbon monoxide is reacted with water to give carbon dioxide and hydrogen by means of a water-gas shift which is preferably conducted downstream. The resulting synthesis gas has hydrogen and carbon dioxide as its main components.

The hydrogen product stream obtained in step (b) should be considered to be a crude hydrogen product and can be freed of impurities by further suitable measures. In particular, suitable methods for the purpose include pressure swing adsorption (PSA) and membrane separation with a hydrogen-selective membrane.

Typical amounts of absorption medium in relation to the carbon dioxide product stream for the purposes of step (d) are 200 ppmv to 2000 ppmv, especially 500 ppmv to 1500 ppmv.

In a preferred embodiment, in the case of physical absorption in step (c), at least one flash step in a flash column is provided, and at least a portion of the absorption medium-containing regeneration stream is fed to said flash column.

A “flash step” here means a pressure-lowering step where the target pressure is always lower than the absorption pressure.

The absorption medium-containing regeneration gas stream is at elevated temperature. This enhances the effect in the flash column in relation to the desorption or stripping of the carbon dioxide without needing any additional energy input. If multiple flash stages are provided, the absorption medium-containing regeneration gas stream may be fed to any desired flash stage. The absorption medium-containing regeneration gas stream is preferably at a pressure of 5 bar or less, and is fed to a flash stage having corresponding or lower pressure.

In a preferred embodiment, in the case of physical absorption, a hot regeneration step in a hot regeneration column is provided in step (c) in flow direction of the absorption medium, and at least a portion of the absorption medium-containing regeneration gas stream is fed to said hot regeneration column.

Such a configuration also enhances the effect in the hot regeneration column in relation to the desorption or stripping of the carbon dioxide without needing any additional energy input.

In a preferred embodiment, the process comprises at least one distillation step in a distillation column for thermal removal of water entrained by the synthesis gas from the absorption medium, and at least a portion of the absorption medium-containing regeneration gas stream is fed to said distillation column.

In this configuration, the heat introduced via recycling of the absorption medium-containing regeneration gas stream contributes to the thermal separation of the absorption medium from water, preferably of methanol and water. In addition, the absorption medium-containing regeneration gas stream may also contain water. This water may have been entrained into the process by the synthesis gas. As a result, this water is not introduced into the absorption medium circuit, which could impair the effect of the absorption medium.

A preferred embodiment of the process comprises heating the second substream of the carbon dioxide product stream to a desorption temperature of 75° C. to 225° C., preferably from 100° C. to 200° C., further preferably from 125° C. to 175° C.

In a further preferred embodiment of the process, the proportion of the volume flow rate of the second substream in the volume flow rate of the overall stream of the carbon dioxide product stream is within a range from 1% to 25%, preferably within a range from 5% to 20%, further preferably within a range from 10% to 15%.

In a further embodiment of the process, there may be at least one further adsorbent disposed downstream of the adsorbent, especially at least one further adsorbent in at least one fixed bed. The at least one further adsorbent is set up for adsorption of further impurities present in the synthesis gas. In particular, the at least one further adsorbent adsorptively removes at least one component from the group of
cyanide-containing compounds (especially hydrogen cyanide),
sulfur-containing compounds (especially hydrogen sulfide, carbon disulfide, thiols, carbonyl sulfide, sulfur-containing heteroaromatics such as thiophene), and
ammonia.

It is further preferable that the absorption medium is adsorbed on the adsorbent owing to a molecular sieve effect of the adsorbent.

The adsorbent is preferably disposed in a fixed bed reactor.

In an embodiment of the process that is preferred here, the process comprises at least two fixed bed reactors, wherein
i. in a first fixed period of time, the adsorbent in the first fixed bed reactor is laden in that the absorption medium-containing carbon dioxide product stream is passed through it, and the adsorbent in the second fixed bed reactor is regenerated in that the regeneration gas stream is passed through it, and
ii. in a second fixed period of time that at least partly follows after the first period of time, the adsorbent in the first fixed bed reactor is regenerated in that the regeneration gas stream is passed through it, and the adsorbent in the second fixed bed reactor is laden in that the absorption medium-containing carbon dioxide product stream is passed through it.

The absorption medium can also be removed from the carbon dioxide product stream with the aid of two or more fixed bed reactors.

Preference is given to choosing a multibed arrangement, such that at least one fixed bed can be regenerated while the other fixed bed(s) is/are still in adsorption mode and are removing absorption medium from the carbon dioxide product stream. On conclusion of the regeneration, the fixed bed in question is switched back to adsorption mode, and another fixed bed with partly or fully laden adsorbent is switched to regeneration mode.

In this connection, the terms “loading” and “regenerating” do not necessarily mean that the respective fixed bed is fully laden with absorption medium or fully freed of absorption medium.

A preferred embodiment of the process comprises desorbing the absorption medium from the adsorbent at a pressure lower than the adsorption pressure for adsorbing of the absorption medium on the adsorbent in step d).

The absorption medium is adsorbed on the solid adsorbent at adsorption pressure. This adsorption pressure may be a pressure corresponding to the desorption pressure in step (c) in the case of physical absorption, or a higher pressure. In the latter case, compression of the carbon dioxide stream obtained in step (c) is required. In order to facilitate desorption of the absorption medium from the adsorbent, the pressure is reduced compared to the adsorption pressure during the desorption with the regeneration gas stream.

A preferred embodiment of the process comprises liquefying the first substream of the carbon dioxide product stream by at least one cooling step and at least one condensation step.

In a further preferred embodiment of the process, the adsorbent is also set up for adsorption of water.

The water is especially water which is entrained by the synthesis gas, i.e. was not fully removable by cooling and condensing prior to the gas scrubbing operation with the absorption medium.

In a further preferred embodiment of the process, the process comprises a solids gasifier for gasification of a carbonaceous feedstock for generation of synthesis gas, and wherein at least a portion of the absorption medium-containing regeneration gas stream is fed to said solids gasifier.

The solids gasifier is configured for generation of synthesis gas from a carbonaceous feedstock. The carbonaceous feedstock is preferably biomass and/or municipal solid waste. The synthesis gas produced by the solid gasifier includes at least hydrogen, carbon monoxide and carbon dioxide. Connected downstream of the solids gasifier is in particular a water-gas shift stage for reaction of the carbon monoxide with water to give hydrogen and carbon dioxide, giving the synthesis gas stream.

The absorption medium-containing regeneration gas stream may especially be used to maintain the pressure in the solids gasifier. In addition, the carbon dioxide in the regeneration gas stream may find use as moderator of the gasification reaction. In this way, for example, it is possible to dispense with the supply of steam as dedicated moderator.

The objects of the invention are also at least partly achieved by a plant for production of hydrogen from a synthesis gas stream comprising at least hydrogen (H₂) and carbon dioxide (CO₂), having the following plant components in fluid connection:
(a) means of providing an absorption medium;
(b) means of removing carbon dioxide from the synthesis gas stream by absorption, by which a carbon dioxide-laden absorption medium and a hydrogen-containing product stream are obtainable;
(c) means of desorbing carbon dioxide from the laden absorption medium, by which a carbon dioxide-depleted absorption medium and an absorption medium-containing carbon dioxide product stream are obtainable;
(d) means of removing absorption medium from the absorption medium-containing carbon dioxide product stream, where the means include at least one fixed bed comprising a solid adsorbent, and of removing the absorption medium from the absorption medium-containing carbon dioxide product stream by adsorption of the absorption medium on the solid adsorbent in the fixed bed, by which a carbon dioxide product stream and an absorption medium-laden adsorbent are obtainable;
(e) means of discharging a first substream of the carbon dioxide product stream from the process;
(f) means of heating a second substream of the carbon dioxide product stream to a desorption temperature, by which a regeneration gas stream is obtainable, and means of passing the regeneration gas stream through the laden adsorbent, such that a regenerated adsorbent by desorption of the absorption medium from the adsorbent and an absorption medium-containing regeneration gas stream are obtainable.

### BRIEF DESCRIPTION OF THE FIGURES

The working example that follows elucidates the invention in detail with reference to the drawing. The working example constitutes an illustrative configuration of the invention without restricting its scope.

The FIGURE shows:

FIG. 1 a highly simplified block flow diagram of a process in one working example of the invention.

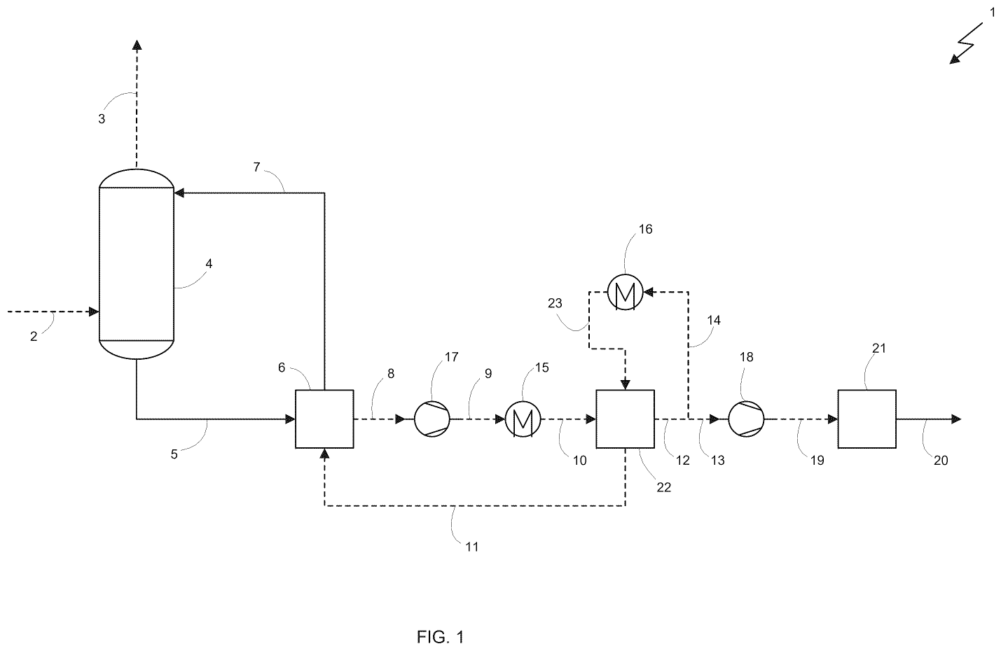

### DETAILED DESCRIPTION OF THE INVENTION

Gas streams are shown as dashed lines, while liquid streams are shown as solid lines. Gas streams may contain a liquid phase, and liquid streams may contain a gas phase. Arrow tips indicate the flow direction of the particular stream. In the example, carbon dioxide is removed by physical absorption. The absorption medium is methanol.

An absorption column 4 is supplied in a lower region with a synthesis gas stream 2 having hydrogen and carbon dioxide as its main components. The absorption column 4 is supplied with a methanol stream 7 composed of regenerated methanol in the top region. In the absorption column 4, which is operated at elevated pressure (for example 40 bar), the synthesis gas stream 2 and the methanol stream 7 are conducted in countercurrent. Within the absorption column 4, the methanol stream has a temperature of less than minus 30° C. The absorption medium (methanol) absorbs the carbon dioxide from the synthesis gas stream 2. A hydrogen stream 3 is discharged from the absorption column 4 in a top region and can be sent to a further purification, for example by pressure swing adsorption (not shown).

Correspondingly, a carbon dioxide-laden methanol stream 5 is drawn off from the bottom of the absorption column 4 and fed to a flash system 6. The flash system 6 may comprise multiple series-connected flash columns (not shown). In the flash system 6, carbon dioxide is desorbed from the carbon dioxide-laden methanol stream 5. This affords the regenerated methanol stream 7. At the same time, a carbon dioxide product stream 8 is obtained, which contains about 1000 ppmv of methanol. In addition, this stream may contain water. The pressure of this carbon dioxide product stream 8 is first increased by a compressor 17 in order to facilitate the subsequent adsorption of methanol and optionally water on the adsorbent. The compressed methanol-containing carbon dioxide product stream 9 is then cooled to about 40° C. by a heat transferrer 15.

The compressed and cooled methanol-containing carbon dioxide product stream 10 is then fed to a fixed bed reactor system 22 having at least two fixed bed reactors (not shown). Within the fixed bed reactors in each case is disposed a fixed bed of an adsorbent that removes methanol and water from the methanol-containing carbon dioxide product stream 10 owing to a molecular sieve effect. After adsorption of the methanol (and any water) on the adsorbent, the respective fixed bed is regenerated. This is effected by branching off a substream 14 from the resultant methanol-free carbon dioxide product stream 12 and heating it to about 150° C. by means of a heat transferrer 16. This affords a regeneration gas stream 23, which is passed through the respective fixed adsorbent bed of the fixed bed reactor system 22. While this is occurring, a further fixed bed reactor of the fixed bed reactor system 22 may be laden with methanol and any water from the compressed stream 10. During the regeneration by the regeneration gas stream 23, the pressure in the respective fixed bed is lowered. The methanol-containing regeneration gas stream 11 generated in the regeneration is returned to the flash system 6. As a result, no losses of carbon dioxide and methanol occur throughout the process. Alternatively or additionally, the regeneration gas stream 11 may be fed to a distillation column (not shown). As a result, any water present in the regeneration gas stream is not entrained into the methanol circuit of the gas scrubbing process.

The substream 13 of the carbon dioxide product stream is compressed in a compressor 18 and then fed as a compressed, now methanol- and water-free carbon dioxide product stream 19 to a unit for carbon dioxide liquefaction 21. In the unit 21, carbon dioxide is liquefied by multiple cooling steps and subsequent condensation. The unit 21 may additionally also have a cryogenic distillation step for further purification of the carbon dioxide product stream 19.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

1 process
2 synthesis gas stream
3 hydrogen stream
4 absorption column
5 methanol stream, carbon dioxide-laden
6 flash system
7 methanol stream, regenerated
8 methanol-containing carbon dioxide product stream
9 methanol-containing carbon dioxide product stream (compressed)
10 methanol-containing carbon dioxide product stream (compressed, cooled)
11 methanol-containing regeneration gas stream
12 carbon dioxide product stream (whole stream, methanol-free)
13 carbon dioxide product stream (first substream)
14 carbon dioxide product stream (second substream)
15, 16 heat transferrer
17, 18 compressor
19 carbon dioxide product stream (first substream, compressed)
20 carbon dioxide product stream (liquefied)
21 unit for carbon dioxide liquefaction
22 fixed bed reactor system
23 regeneration gas stream

1. A process for separating carbon dioxide from a synthesis gas stream comprising at least hydrogen and carbon dioxide, having the process steps of
(a) providing an absorption medium;
(b) removing carbon dioxide from the synthesis gas stream by absorption, thereby producing a carbon dioxide-laden absorption medium and a hydrogen-containing product stream;
(c) desorbing carbon dioxide from the laden absorption medium by a desorption step, thereby producing a carbon dioxide-depleted absorption medium and an absorption medium-containing carbon dioxide product stream;
(d) removing absorption medium from the absorption medium-containing carbon dioxide product stream by adsorption of the absorption medium on a solid adsorbent, thereby producing a carbon dioxide product stream and an absorption medium-laden adsorbent;
(e) discharging a first substream of the carbon dioxide product stream from the process;
(f) heating a second substream of the carbon dioxide product stream to a desorption temperature, thereby producing a regeneration gas stream, and passing the regeneration gas stream through the laden adsorbent, thereby producing a regenerated adsorbent by desorption of the absorption medium from the adsorbent and an absorption medium-containing regeneration gas stream.

2. The process according to claim 1, wherein a physical absorption medium is provided in step (a), the carbon dioxide is removed in step (b) by physical absorption at absorption pressure, and the carbon dioxide is desorbed in step (c) by at least one pressure-lowering step at desorption pressure, where the desorption pressure is lower than the absorption pressure.

3. The process according to claim 1, wherein a chemical absorption medium is provided in step (a), the carbon dioxide is removed in step (b) by chemical absorption at an absorption temperature, and the carbon dioxide is desorbed in step (c) by at least one heating step at a regeneration temperature, where the regeneration temperature is higher than the absorption temperature.

4. The process according to claim 1, wherein at least one flash step in a flash column is provided in step (c), and wherein at least a portion of the absorption medium-containing regeneration gas stream is fed to said flash column.

5. The process according to claim 1, wherein a hot regeneration step in a hot regeneration column is provided downstream of step (c) in flow direction of the absorption medium, and wherein at least a portion of the absorption medium-containing regeneration gas stream is fed to said hot regeneration column.

6. The process according to claim 1, further comprising at least one distillation step in a distillation column for thermal removal of water entrained by the synthesis gas from the absorption medium, and wherein at least a portion of the absorption medium-containing regeneration gas stream is fed to said distillation column.

7. The process according to claim 1, wherein the second substream of the carbon dioxide product stream is heated to a desorption temperature of 75° C. to 225° C.

8. The process according to claim 1, wherein the proportion of the volume flow rate of the second substream in the volume flow rate of the overall stream of the carbon dioxide product stream is within a range from 1% to 25%.

9. The process according to claim 1, wherein the absorption medium is adsorbed on the adsorbent owing to a molecular sieve effect of the adsorbent.

10. The process according to claim 1, wherein the adsorbent is disposed in a fixed bed reactor.

11. The process according to claim 10, wherein the process comprises at least two fixed bed reactors, wherein
i. in a first fixed period of time, the adsorbent in the first fixed bed reactor is laden in that the absorption medium-containing carbon dioxide product stream is passed through it, and the adsorbent in the second fixed bed reactor is regenerated in that the regeneration gas stream is passed through it, and
ii. in a second fixed period of time that follows after the first period of time, the adsorbent in the first fixed bed reactor is regenerated in that the regeneration gas stream is passed through it, and the adsorbent in the second fixed bed reactor is laden in that the absorption medium-containing carbon dioxide product stream is passed through it.

12. The process according to claim 1, wherein the absorption medium is desorbed from the adsorbent at a pressure lower than the adsorption pressure for adsorbing of the absorption medium on the adsorbent in step d).

13. The process according to claim 1, wherein the first substream of the carbon dioxide product stream is liquefied by at least one cooling step and at least one condensation step.

14. The process according to claim 1, wherein the adsorbent is also set up for adsorption of water.

15. The process according to claim 1, wherein the process comprises a solids gasifier for gasification of a carbonaceous feedstock for generation of synthesis gas, and wherein at least a portion of the absorption medium-containing regeneration gas stream is fed to said solids gasifier.

16. A plant for production of hydrogen from a synthesis gas stream comprising at least hydrogen and carbon dioxide, having the following plant components in fluid connection:
(a) a means of providing an absorption medium;
(b) a means of removing carbon dioxide from the synthesis gas stream by absorption, by which a carbon dioxide-laden absorption medium and a hydrogen-containing product stream are obtainable;
(c) a means of desorbing carbon dioxide from the laden absorption medium, by which a carbon dioxide-depleted absorption medium and an absorption medium-containing carbon dioxide product stream are obtainable;
(d) a means of removing absorption medium from the absorption medium-containing carbon dioxide product stream, where the means include at least one fixed bed comprising a solid adsorbent, and of removing the absorption medium from the absorption medium-containing carbon dioxide product stream by adsorption of the absorption medium on the solid adsorbent in the fixed bed, by which a carbon dioxide product stream and an absorption medium-laden adsorbent are obtainable;
(e) a means of discharging a first substream of the carbon dioxide product stream from the process;
(f) a means of heating a second substream of the carbon dioxide product stream to a desorption temperature, by which a regeneration gas stream is obtainable, and means of passing the regeneration gas stream through the laden adsorbent, such that a regenerated adsorbent by desorption of the absorption medium from the adsorbent and an absorption medium-containing regeneration gas stream are obtainable.
